(19) United States
(12) Patent Application Publication
(10) Pub. No.: US 2018/0198833 A1
(43) Pub. Date: Jul. 12, 2018

(54) User Assembled Content Delivered In A Media Stream Via A Virtual Community

(71) Applicant: Leo T. ABBE, New York, NY (US)

(72) Inventor: Leo T. ABBE, New York, NY (US)

(21) Appl. No.: 15/864,589

(22) Filed: Jan. 8, 2018

Related U.S. Application Data
(60) Provisional application No. 62/443,303, filed on Jan. 6, 2017.

(51) Int. Cl. H04L 29/06; G06F 21/32; G06Q 30/02; G06Q 50/00

(52) U.S. Cl. CPC H04L 65/4084; G06Q 50/01; G06Q 30/0251; G06F 21/32

(57) ABSTRACT

A system and method for a user to send a message to a group of users of a streaming media service. The message is directed to a specific group and is sponsored by an advertising entity. The message is transmitted to the group with a sponsor message when a member of the group either accesses or logs into the streaming media service. When a user logs into the streaming media service the message is presented to the user based at least in part on their membership in the group along with a sponsor advertisement.

### RELATED APPLICATIONS

This application claims priority from U.S. Provisional Patent Application Ser. No. 62/443,303 which was filed on Jan. 6, 2017.

### BACKGROUND OF THE INVENTION

### 1. Field of the Invention

The present invention relates to streaming media and more particularly to providing targeted message content to a group of users via one or more streaming media services along with the streaming media delivered by the specific streaming media service.

### 2. Description of the Related Art

Currently, a radio listener, identified as a user, is able to call or text a radio station or a specific DJ and request a song. Along with or instead of the song request, the listener can send a message, referred to as a “Shoudout”, to another listener. The user must rely on the DJ to actually play the request or air the Shoudout. Unless the user for whom the dedication was made or who was the target of the Shoudout happens to be listening to a radio, and the particular station when the request or Shoudout is aired, the listener will never know that the dedication was made or a special message sent. Further, there is no way for the requestor to reach a targeted community that would be interested in the message.

### SUMMARY OF THE INVENTION

With listeners migrating to streaming media services, there is no way to send a Shoudout or dedicate songs to a particular listener or a group of listeners that share a common interest. What is needed is a system and method to enable users of interactive social groups to send messages and/or dedicate songs to another user or group of users using a streaming media service. Additionally, what is needed is a way to subsidize these Shoudouts or dedications, preferably by sponsors, and more particularly by advertising sponsors.

According to the one embodiment of the present invention, a user is able to send a Shoudout to another user of a streaming media service. The Shoudout is directed to a specific recipient and is sponsored by an advertising entity. The Shoudout is transmitted to the recipient with a sponsor message when the recipient either accesses or logs into the streaming media service. In one embodiment, the recipient is notified that a Shoudout or dedication is available for the recipient to listen to. When the user logs into the streaming media service the Shoudout is presented to the recipient along with a sponsor advertisement.

According to one embodiment of the invention, listeners of and viewers of selected audio and audio/video content select their virtual group, referred to as a “Shoudout Crowd”, which is defined as a set of users with a common affiliation or affinity, such as the students of a particular school, or the fans of a specific sports team. By creating or selecting a virtual group, each user is opting in to have their selected streaming media content occasionally interrupted in order to hear and/or see user generated content from other users within that “Shoudout Crowd.” In other words, a user that creates a group or a user that selects and enters a group acknowledges that their streaming media content will be enhanced with user generated content. This user generated content can be immediately followed by a message from a sponsor, which can be targeted contextually to the user generated content, using word/phrase matching from transcription, or can be targeted to the characteristics inherent to the “Shoudout Crowd”, or to other data points.

Accordingly to one embodiment of the invention, each user can access one or more streaming media services via a dedicated access point. For example, streaming media services are accessed via a Web page where a user first selects a virtual group and then selects the streaming service. Alternatively, each streaming media services has its own access point. For example, a user seeking to access their streaming audio service accesses a web page dedicated to that service. The user selects their “Shoudout Crowd” and then logs into the service. If a desired “Shoudout Crowd” is not available, the user has the opportunity to create a “Shoudout Crowd” and invite other users to join this newly formed “Shoudout Crowd.” Every member of a “Shoudout Crowd” will receive dedications or Shoudouts that other users record. According to one aspect of the invention, the user that created the dedication can select a sponsor. The dedication or Shoudout with a message from the selected sponsor are presented to the “Shoudout Crowd”.

According to one aspect, the “Shoudout Crowd” can have a dedicated sponsor. The sponsor attaches a message to each Shoudout or selected Shoudouts sent to the “Shoudout Crowd”. For example, a sports team such as the New York Yankees sponsors a “Shoudout Crowd”. The members of this “Shoudout Crowd” are all fans. As they submit Shoudouts, the sponsor can attach a message.

In one embodiment, user generated Shoudouts become part of the “Shoudout Crowd” media stream without a sponsor message. The user creates the Shoudout and sends it to the “Shoudout Crowd” without selecting a sponsor. In one embodiment, the user is able to opt out of including a sponsor message.

According to one aspect of the invention additional content in a media stream is provided by receiving at a server a selection of a virtual community from a remote device, receiving at the server content from the remote device, selecting a sponsor for the additional content, generating at the server the additional content by combining one or more of an identifier of the recipient, the content, and an identifier of the sponsor, and transmitting the additional content to a media stream server for delivery to the virtual community.

As a user listens to their playlists from their streaming media service, they hear a Shoudout from their Crowd every few songs.

Instead of a user logging in to a streaming media service directly, the user logs into an aggregating service. The aggregating service provides virtual groups that combines multiple users with a similar interest. The interest can be a school, sports team, hobby, political affiliation, occupation, or the like. Alternatively, the streaming media service can provide the user aggregation after log-in. After logging into the streaming media service the user can select the group or groups. A user can be a member of multiple groups. In one embodiment, the user can log into multiple groups simultaneously.

The streaming media service can be an audio service providing audio content such as music, radio shows, talk radio, audio books, or the like or a video streaming service that provides movies, TV shows, independent content, user generated content, or the like.

If a particular group is not available either through the aggregating service or the streaming media service provider, a user can create a particular group. According to one aspect of the invention, if a user creates a group using the streaming media service provider, the group is also created at the aggregating service and vice versa. It should be noted that not all streaming media service providers may want to participate with the aggregating service. As such, the group selection may be presented after logging into the service, although it can also be presented to the user prior to logging in.

In one embodiment, group members can view or listen to play lists or recommendations of other group members. In one embodiment, the aggregating service provides curated content lists.

The groups can be public or private at the discretion of the user that formed the “Shoudout Crowd”, hereinafter the “Crowd Administrator”. Public groups are accessible to every user of the streaming media provider. Private groups are password enabled or are accessed by accepted members only. A user seeking access to a private group must be invited either by the Crowd Administrator or an existing member of the Crowd. The user seeking admission to the “Shoudout Crowd” messages the group administrator seeking entry to the Shoudout Crowd. Alternatively, an invitation is not required but the user is still required to seek admission to the private group.

In one embodiment, a Private Crowd is a subscription based group. A user, as Crowd Administrator, forms a Public or Private Crowd, and if Private, chooses a password, which is then passed on to the invitees. The Crowd Administrator is free to share that password with anyone they wish. Once approved, the user receives a password, which can be changed by the user, or the user's streaming media provider user information is added to an approved list.

According to one aspect of the invention the user can direct Shoudouts to an individual or the group.

Listeners of music streams can opt in to hear user generated content from their affiliations. The Crowds can also be private, meaning exclusivity. Only people with a password can send or “drop” a Shoudout into a Private Crowd and can only opt in with that password to hear from that Crowd with a password.

According to one aspect of the invention, the virtual community is notified that there is additional content available for receipt.

Accordingly to one embodiment of the invention, each user has an App that links with one or more streaming media services. In one embodiment, each streaming media service has a dedicated App. To send a dedication or Shoudout, a user records a Shoudout and/or selects a song for the dedication. Next, the user selects a sponsor. Finally, the dedication or Shoudout with a message from the selected sponsor are presented to the recipient.

In one embodiment, user generated Shoudouts become part of a recipient's media stream without a sponsor message. The user creates the Shoudout and sends it to the recipient without selecting a sponsor. In one embodiment, the user is able to opt out of including a sponsor message.

According to one aspect of the invention additional content in a media stream is provided by receiving at a server a selection of a recipient from a remote device, receiving at the server content from the remote device, selecting a sponsor for the additional content, generating at the server the additional content by combining one or more of an identifier of the recipient, the content, and an identifier of the sponsor, and transmitting the additional content to a media stream server for delivery to the recipient.

According to one aspect of the invention, the recipient is notified that there is additional content available for receipt.

According to one aspect of the invention, instructions are provided to the media stream server to delay providing the media stream until the additional content is transmitted to the recipient.

According to one aspect of the invention, the notification of the content from the remote device is received via one of text, email, voice, and fax.

According to one aspect of the invention, the content is one of received in a format that can be analyzed by the server or converted to the format that can be analyzed by the server. In other words, the content is either readable by the server or the server is configured to convert the content into a useable format.

According to one aspect of the invention, at least one of the remote device and a user of the remote device is authenticated.

According to one aspect of the invention, the authentication of the one of the remote device and a user of the remote device is via one of a PIN and biometric data.

According to one aspect of the invention, a user of the remote device selects the sponsor for the additional content.

According to one aspect of the invention, the additional user generated content is analyzed for one or more of specific words, phrases, images, or the like, and the sponsor for the additional content is selected based at least in part on the analyzed content.

According to one aspect of the invention, the sponsor is selected based at least in part on a minimum quantity of additional content that the sponsor will sponsor.

According to one aspect of the invention, the server determines if a recipient has opted out of receiving a sponsor message.

According to one aspect of the invention, the content is analyzed for inappropriate content; and either a warning is provided to the remote device that the content is inappropriate and at least one of the mobile device and a user of the mobile device is blocked from providing content.

According to one aspect of the invention, the sponsor is selected based at least in part on one or more of specific keywords, selected demographic groups, zip code, and a budget.

According to one aspect of the invention, the additional content is provided to a plurality of listeners in addition to the recipient.

One aspect of the invention is a system configured to provide additional content in a media stream. The system includes a remote device, a server configured to: receive a selection of a recipient from the remote device, receive content from the remote device, generate the additional content by combining one or more of an identifier of the recipient, the content, and an identifier of a sponsor, and select a sponsor for the additional content. The system also includes a media stream server configured to receive the additional content and transmit the additional content to the recipient.

One aspect of the invention is a system configured to provide additional content in a media stream to a virtual community. The system includes a remote device, a server configured to: receive a selection of a virtual community from the remote device, receive content from the remote device, generate the additional content by combining one or more of an identifier of the virtual community, the content, and an identifier of a sponsor, and select a sponsor for the additional content. The system also includes a media stream server configured to receive the additional content and transmit the additional content to the virtual community.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a flowchart of the method;

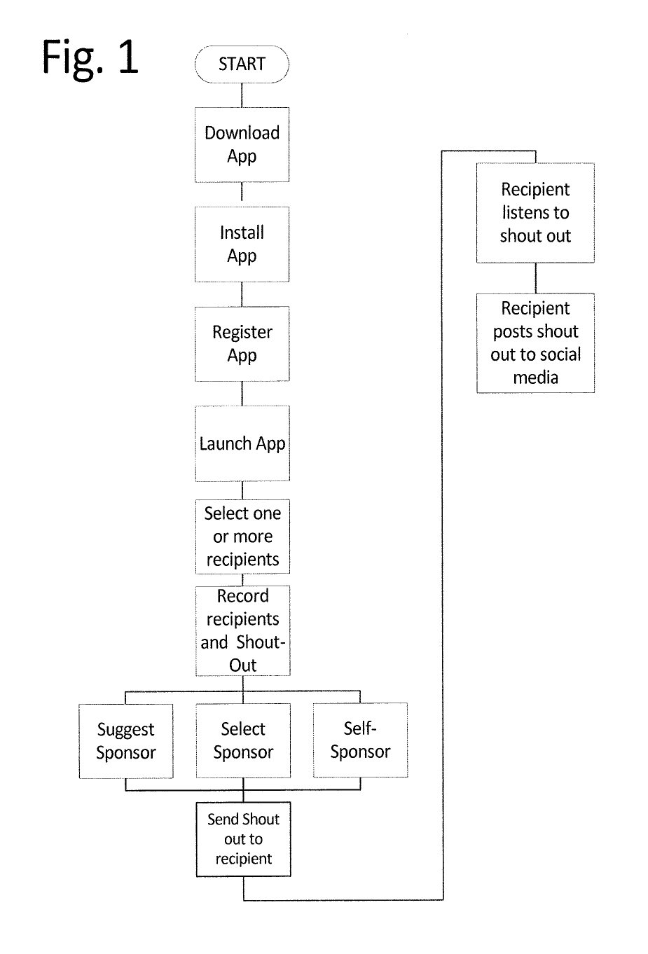

FIG. 2 is a depiction of the system; and

FIG. 3 is a flowchart of the method.

### DETAILED DESCRIPTION OF THE PRESENTLY PREFERRED EMBODIMENTS

The following description applies to both single recipients as well as group affiliations. The embodiments are described with respect to a single recipient but can be scaled to include the features discussed above.

Initially, an App is downloaded to a user device such as a Smart Phone or the like. Alternatively, the App can be downloaded to a personal computer. Once the App is downloaded and installed the user preferably registers an account. In one embodiment, the user must register an account. Registration provides accountability to ensure appropriate content for Shoudouts. One way in which a user can be registered is to provide a mobile number that is verified with a text message containing a unique code. The unique code is then entered in the App to verify the user. Alternatively, a PIN can be sent via mail or another verifiable method. Users may also join groups. Groups may involve a second registration step via which users join specific public or private groups. Private groups use authentication provided by a password, user information via a streaming service, or the like.

During the registration process users provide demographic data that will be used to match users with advertising sponsors for both sending and receiving Shoudouts. The demographic data may also be used to disseminate Shoudouts to a group as discussed below. The demographic data that is collected includes date of birth, gender, zip code, education, hobbies, skills, and the like. An email address is also preferably provided by the user during the registration process. In one embodiment, an email must be provided. Additionally, during the registration process, a user enters their user name and password for the streaming media services to which they subscribe. In one embodiment, the App accesses a user's contacts to generate a list of potential Shoudout and/or dedication receivers. Additionally, when the Shoudout initiator is sending a Shoudout to someone that is not a contact, a specific email address or mobile phone number can be entered.

When a user decides to send a Shoudout or make a dedication, the user launches the App. The App can be launched independently or from within the streaming media service. The first step once the App is launched is to select a recipient for the Shoudout. One or more recipients for the Shoudout can be selected either from the previously entered contact list or one or more newly entered recipients. Preferably, as new Shoudout recipients are entered they are stored in the user's contact list. If the recipient is already a contact, the user can use a name or a nickname to select the recipient. It should be noted that because most streaming services require registration by email, an email address can be used to find the recipient subscribing to a particular streaming service.

Alternatively, if the user is a member of one or more groups, the user logs into or chooses a group and sends a Shoudout to the group. The Shoudouts or group messages are preferably related to the group.

In one embodiment, the App is tied to a specific streaming service. Alternatively, the App can be tied to a central server that interacts with the various streaming services either directly or via the Internet to determine to which streaming service a Shoudout recipient subscribes. In this manner, Shoudouts could be sent out across various platforms to multiple users. In one embodiment, the App provides an opportunity to log into a group. This allows the user to share content across the entire group, which may encompass multiple platforms or streaming media services.

Once the user selects a recipient or group of recipients the user is prompted to record the name of the recipient and the Shoudout. In one embodiment, there is no need to record a recipient name as the Shoudout is being sent to a Crowd. Alternatively, the recipient name can be related to the Crowd, such as “Yankees Fans”, NYU Students, or the like. The user is given an opportunity to listen to and accept the recorded Shoudout. If the user is not satisfied with the Shoudout, the Shoudout can be re-recorded. Voice recognition software or image recognition in the case of video recordings, is used to analyze the Shoudout for prohibited words and advertiser selected search words. In one embodiment, the Shoudout has a predetermined duration, such as 10 seconds. Once the user accepts the Shoudout the user selects a sponsor for the Shoudout. In one embodiment the App will present the user with a list of sponsors from which the user selects a single sponsor. In one embodiment, Shoudout sponsorships is marketed to the advertisers directly or by a third party service, whereby matches are made based on any number of data points, such as Crowd, context of the message, geographic location, and the like, without involving the creator of the message. The sponsor list is generated based on the demographic information the user initially entered during registration process. Additionally, sponsors may be suggested based on the demographic data of the recipient, if known, or usage patterns of the user. Still further, the sponsor list can be generated based on the content of the Shoudout.

If the user has a particular sponsor in mind that does not appear in the suggested list, the user can search for that sponsor. If the desired sponsor is not present in the list, or if the user wants to use a non-participating sponsor, the user can input the sponsor information. The sponsor information would include name, address, telephone number, email contact information, and the like. If a non-participating sponsor is entered by a user, the system will advise the user if the sponsor is not currently available. The system will then inform the nonparticipating sponsor that a user would like them to sponsor a Shoudout. The App administrators can then attempt to engage this entity as an advertising sponsor. If the nonparticipating sponsor becomes a participating sponsor, the user is notified that the sponsor has signed onto to the service.

In one embodiment, if the User suggested a non-participating sponsor, the system sends a mock Shoudout file and the contact info provided to the lead generation team, who then seek out the potential sponsor and sell them on the service.

After the Shoudout is recorded and the sponsor is selected the user selects a date and time range during which the Shoudout should be delivered. In one embodiment, the streaming service or app notifies the user when the recipient typically logs into the streaming service. The system sends the full Shoudout audio file, which includes the sponsor message, to the various streaming services along with the recipient's email in order to create a handshake. The file that the streaming service receives preferably includes the user selected delivery date and time. In one embodiment, the system provides a budget to the various streaming services so that they know how many ad runs to play against other “similar” listeners in a particular geographic or demographic group of the recipient. The services have this information as a result of their registration process.

When a streaming service runs the Shoudout or dedication for a recipient, the streaming service immediately notifies the system, so as to avoid redundant runs amongst the other services. Further, as a streaming media service runs the ad against other “similars” the streaming media services also provide real time information so that a sponsor's budget is reflected on a real time basis to all the streaming services.

In one embodiment, if the recipient has not logged into the streaming service by the end of the time range the user entered, an alert is sent to the recipient either by email or text notifying them that a Shoudout has been sent to them. Alternatively, when the user sends the recipient a Shoudout the recipient is notified by text, email, or the like, that a Shoudout is waiting for them. However, a notification to the user eliminates the element of surprise for the recipient when they hear the Shoudout or dedication on the streaming service. The alert email or text message can include a link to log into the streaming service. If the email or mobile number used to provide the alert message is not the email or mobile number used for the streaming service, the recipient is given the opportunity to log into the streaming service with their registered account information. Preferably, this information is stored by the App so that future Shoudouts are linked to the appropriate streaming media account. Alternatively, the recipient is given the opportunity to register with the steaming media service. The linking can be done by cookies, a database stored on a server, or the like.

If the recipient does not have a streaming service account, when the notification alert link is accessed, the recipient is given the opportunity to register with the streaming service. Once registered, the recipient would hear the Shoudout and sponsored ad. A typical Shoudout would be “happy birthday Jane from your friend Sue, sponsored by your friends at Sponsor.” The “happy birthday Jane from your friend Sue” portion of the Shoudout is preferably recorded by Sue. Alternatively, the Shoudout can be typed and read by a generated voice.

It should be noted that in one embodiment, if a recipient signs up with a streaming service a referral fee is earned by the App provider for referring a new user to the streaming service.

If the recipient does not have the App, when the recipient receives the above email they are given the opportunity to download the App. In one embodiment, the email includes a radio button allowing the recipient to send a thank you response to the initial sender. This email as noted above will also include a link to download the Shoudout App as well as the App for the streaming service. The App also has a provision to send a thank you to the sender of the Shoudout.

In a preferred embodiment, the App includes links to social media services so that once the recipient listens to the Shoudout the Shoudout can be posted to a social media network or shared with friends via text, email, and the like. Preferably, the App tracks when a recipient posts the Shoudout to a social media site. The App would also include an alert to report inappropriate or abusive Shoudouts.

In one embodiment, the user may select a specific song to be dedicated to the recipient. The sponsor ad, Shoudout, and song would then be delivered to the recipient. The dedicated song can be selected from a list or specifically designated by the user.

In one embodiment, the Shoudouts are sent by sponsors. The sponsor selects a target demographic audience and sends a Shoudout with their ad to matching recipients. If the App is on an iPhone or Android Platform, the budget for the Shoudouts can be an in-App purchase. Alternatively, the sponsor is prompted to provide credit card or bank transfer information for billing purchases. The budget for sponsored Shoudouts comprises the cost of the recipient to play the link as well as other advertising and operating costs.

In one embodiment, the sender is the sponsor and the sender decides their budget. If the app is on an iPhone, the budget is treated as an in-app purchase, if not, the sender is prompted to provide credit card or banking information. A budget consists of the cost of recipient play plus all plays in selected demographics or geographic regions.

On the system side of the App, sponsors can download a sponsor App that allows them to manage their sponsor campaigns. The sponsor App allows the sponsor to upload an audio file or create one on demand. When a sponsor initially downloads and activates the sponsor App they enter identifying information as well as credit card or banking information to pay for the sponsor campaigns. The App allows sponsors to create ad campaigns that include targeted demographic audiences, budgets, and specific budgets for targeted campaigns such as a campaign in a specific zip code, to a particular age group, or the like. It should be noted that multiple ad campaigns with multiple different ads can be prepared and presented simultaneously. Multiple different ads or targeted ads prepared for target audiences.

Sponsors can also register as ready and willing sponsors (RAW Sponsor). As a Raw Sponsor the sponsor can be listed as a potential sponsor and if chosen, the sponsor can hear the proposed Shoudout and decide whether to use a canned ad or one of a plurality of prepared ads, or create an ad specifically for the recipient or recipient group. In addition, as a RAW Sponsor, the sender recorded name of recipient can be overridden and instead, the recorded name can be incorporate into their ad, using the Sender recording as a guide for pronunciation. For example, instead of the standard Shoudout, the RAW sponsor Shoudout may be “Sponsor wishes Jane a happy birthday from your friend Sue.” Portions of Sue's recording would be used to create the RAW Shoudout.

There will also be a portal website that gives them the ability to monitor real time progress of their campaigns. They can see the number of campaigns running, their used and unused budget per campaign, the number of times the ad was posted to social networks or shared with friends, the number of times the ad was played on social networks, etc. They can re-allocate unused ad budgets in real time.

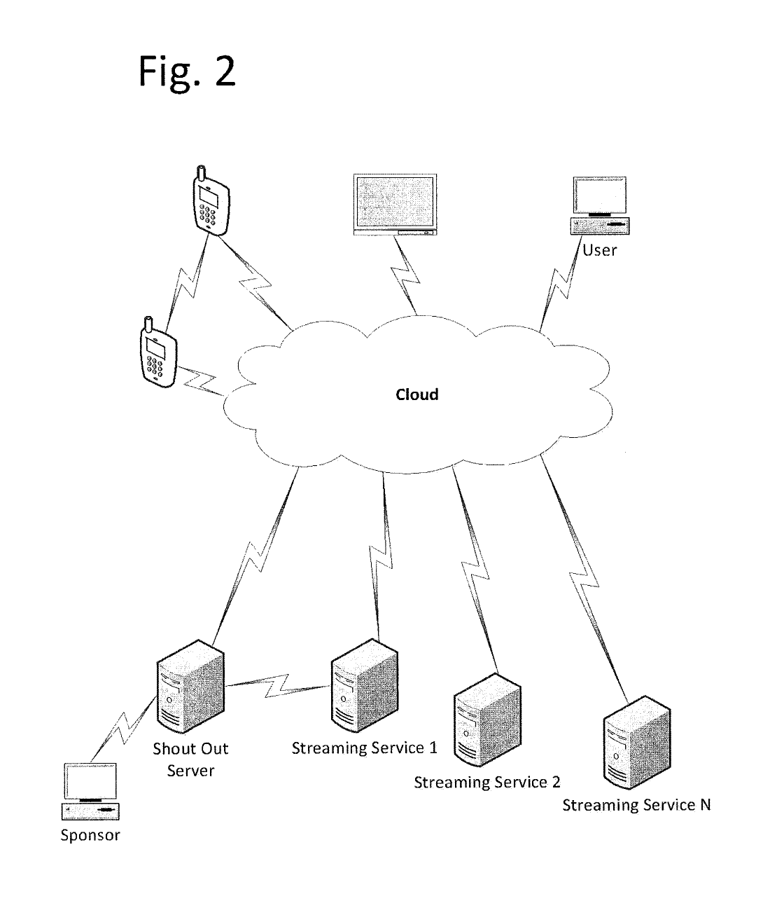

As shown in FIG. 2, users can access the system from smartphones, laptop computers, personal computers, or the like. In one embodiment, Shoudouts notifications are delivered directly to a recipient from a user. The recipient then retrieves the Shoudout from the streaming service with a report delivered to the Shoudout server. Alternatively, the Shoudout is delivered directly to a recipient from a user. The recipient then provides a notification to the Shoudout server when the Shoudout is accessed.

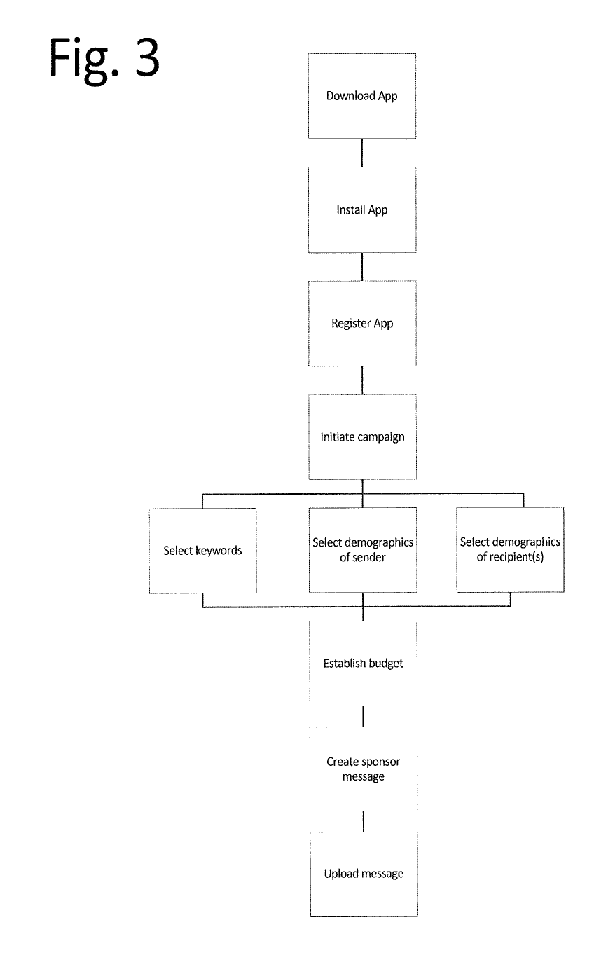

As shown in FIG. 3, a sponsor downloads and installs an app. Preferably, the app is specifically tailored for sponsors. Alternatively, the same app is used by sponsors and Shoudout senders and recipients. The sponsors register so that they can sponsor Shoudouts. Registration includes providing billing information, contact information, and the like. Once registered, a sponsor can initiate a campaign. A campaign relates to sponsoring Shoudouts related to specific keywords, selected demographic groups, and the like. For example, a sponsor can elect to sponsor Shoudouts that have the word “birthday” or a sponsor can send a Shoudout to a specific demographic group such as the high school graduating class in a specific zip code. A sponsor then establishes a target budget for a campaign. Each sponsored Shoudout has a cost associated with it. The budget establishes how many Shoudouts a sponsor will be affiliated with. The sponsor then creates a sponsor message and uploads it for dissemination to the Shoudout recipients. It should be noted that the steps in establishing a campaign can be performed in any order. As sponsored Shoudouts are sent to recipients, the sponsors are updated. In this way, sponsors can vary their budget, message, or the like.

In one embodiment, advertisements or sponsors for “Shoudout” messages are selected or determined based on specific contextual content of a message. For example, a user's “Shoudout” message can be happy birthday, happy Valentine's day, congratulations on your game, happy anniversary, or the like. The message is initially transcribed at a server. In one embodiment, after the “Shoudout” message and/or image is transcribed and/or meta tagged, the message content is compared to a go/no-go list. The go/no go list screens the message for inappropriate or offensive content. A contextual analysis of the message is also performed to target contextual meanings in the “Shoudout” message. The contextual analysis matches sponsors and advertisements that are delivered to the ultimate message recipient and any others who will hear the message.

In one embodiment, access to the application is limited by a PIN. The user must enter the PIN to access the functionality of the application. The PIN can be selected during initial set-up of the application or at a future time during use. In one embodiment, the PIN is verified by the Shoudout Server. Additionally, the PIN can authenticate a user to the Shoudout Server and/or Streaming Service. If the authentication using the PIN fails, the application can be terminated remotely by the Shoudout Server.

The application is configured to be terminated remotely. If the user violated a policy of if the authentication fails, the user's access to the application is blocked.

The delivered advertisement that is targeted to a third party, the “Shoudout” recipient, is based on input from a first party, the user. In this manner, it is not merely the chosen Crowd or words in the message that results in the delivered advertisement, but the contextual meaning of the message. For example, the context of the message may be an anniversary, but the user may not use the word anniversary. In this manner, advertisers select message keywords as well as contextual elements for which they want to advertise.

In one embodiment, the user selects a recipient and provides a “Shoudout” message. While the user preferably records the “Shoudout” a prerecorded “Shoudout” message may be used. Alternatively, a user can select a category for the “Shoudout” message such as birthday and suggested messages are displayed that the user can read and record. Advertisers select messages with which they want to include their advertisement that will be presented to recipients and others. The selection is based on keywords in the message, contextual analysis of the message, or a combination of contextual analysis and keywords. Once the message and advertisement are matched and the “Shoudout” message is prepared, the “Shoudout” message is presented to the recipient, as well as others that may or may not have a social connection to the recipient, and who may or may not be anticipating the play of the “Shoudout”.

In one embodiment, the User does not select a sponsor, but rather the sponsor is chosen by information from the Shoudout gleaned by an ad server, which is a part of the Shoudout Server or another server. The Shoudout is contextually analyzed for key words or ideas and an ad is selected based on the context of the user's message. In other words, for contextual advertising the user would not need to select the sponsor. The system adapts depending on how the user enters the Shoudout. If the Shoudout is entered textually, by fax, email, text, or the like, an OCR function or equivalent is performed to convert the text into a form that can be analyzed by the ad server. If the Shoudout is entered by voice, for example over the phone, a speech to text conversion is performed.

In one embodiment, users are not given a choice of radio station or streaming service. A specific station or streaming service is provided for the “Shoudout” message. The recipient will receive a communication, email, text message, voice message, or the like informing the recipient to listen to the radio station or streaming service for a message. Alternatively, the user is allowed to select the radio station or streaming service.

In one embodiment, the delivered message will have a lead-in designed to condition the audience to the fact that they are about to hear/see some user generated content, which is preferably a musical lead-in. Next, the phrase “Shoudout” will be heard, and then the message will be played. Finally, the sponsor portion will be played, which includes “brought to you by” then the keyword advertisement. In a group scenario, the sponsor may a group organizer such as a corporation, sports team, school, or the like.

In one embodiment, there is a small business feature, although this feature can be used for any advertiser. A small business will register with the “Shoudout” service. A short advertisement, typically 6-8 seconds is prepared by the small business proprieto. The business elects to have their advertisement played for recipients in, for example, a specific zip code. The small business provides a budget and the advertisement is played until the budget is exhausted. While presented as geographically based, the advertisements can be contextual as well, with or without a geographic component. In this manner a business can promote itself to local users or a small business can present a niche product to a broader market.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A method of providing additional content in a media stream comprising:
receiving at a server a selection of a group from a remote device;
receiving at the server content from the remote device;
selecting a sponsor for the additional content;
generating at the server the additional content by combining one or more of an identifier of the group, the content, and an identifier of the sponsor; and
transmitting the additional content to a media stream server for delivery to the recipient.

2. The method of claim 1, wherein the additional content is at least one of audio, video, and text.

3. The method of claim 2, wherein the additional content is provided by a member of the selected group.

4. The method of claim 3, further comprising verifying that the member is a member of the selected group.

5. The method of claim 4, wherein the verification is at least one of a PIN and biometric data.

6. The method of claim 1, wherein the group comprises a plurality of users and entry to the group requires an invitation to join the group.

7. The method of claim 3, wherein the additional content is created by the member.

8. The method of claim 7, wherein the additional content is analyzed for one or more of specific words, phrases, and images.

9. The method of claim 8, wherein if the additional content does not meet predetermined standards it is rejected.

10. The method of claim 8, wherein the predetermined standards comprise one or more of unacceptable keywords, unacceptable images, and unacceptable symbols.

11. A system configured to provide additional content in a media stream comprising:
a remote device;
a server configured to:
receive a selection of a group from the remote device;
receive content from the remote device;
generate the additional content by combining one or more of an identifier of the recipient, the content, and an identifier of a sponsor;
select a sponsor for the additional content; and
a media stream server configured to receive the additional content and transmit the additional content to the group.
